(19) United States
(12) Patent Application Publication
(10) Pub. No.: US 2026/0143365 A1
(43) Pub. Date: May 21, 2026

(54) IN-VEHICLE DEVICE

(71) Applicant: TOYOTA JIDOSHA KABUSHIKI KAISHA, Toyota-shi (JP)

(72) Inventors: Noriaki ITO, Toyota-shi (JP); Shingo Sugimoto, Nagoya-shi (JP); Yuma Ito, Chiryu-shi (JP)

(73) Assignee: TOYOTA JIDOSHA KABUSHIKI KAISHA, Toyota-shi (JP)

(21) Appl. No.: 19/379,805

(22) Filed: Nov. 5, 2025

(30) Foreign Application Priority Data
Nov. 19, 2024 (JP) 2024-201833

(51) Int. Cl. H04W 24/04; H04W 4/48; H04W 48/20

(52) U.S. Cl. CPC H04W 24/04; H04W 4/48; H04W 48/20

(57) ABSTRACT

An in-vehicle device includes a communication unit connectable to either a primary line or a secondary line of mobile communication, and a controller configured to cause the communication unit to switch to the secondary line when a failure has occurred in the primary line, in which the controller is configured to execute, when a condition under which communication through the primary line for providing a service to a user is disconnectable is satisfied, switching processing of causing the communication unit to switch to the secondary line even in a case where the failure has not occurred in the primary line.

### CROSS-REFERENCE TO RELATED APPLICATION

This application claims priority to Japanese Patent Application No. 2024-201833 filed on November 19, 2024. The disclosure of the above-identified application, including the specification, drawings, and claims, is incorporated by reference herein in its entirety.

### BACKGROUND

### 1. Technical Field

The present disclosure relates to a system and an operation method of the system.

### 2. Description of Related Art

In a communication device connected to a network, a redundant configuration is employed in which a backup secondary line is switched in a case where a failure occurs in a primary line used in a normal case. For example, Japanese Unexamined Patent Application Publication No. 2024-123687 (JP 2024-123687 A) discloses a communication system including a module that checks connectivity of a primary line and a secondary line.

### SUMMARY

In an in-vehicle device that is mounted in a vehicle and that performs communication via mobile communication, it is difficult to include a module that can connect to a plurality of lines at the same time due to constraints related to circuit complexity and cost, and connectivity of a secondary line cannot be checked in a case where a primary line is in use. Therefore, it is needed to resolve such a problem.

Hereinafter, an in-vehicle device and the like capable of smoothly checking connectivity of a line will be disclosed.

An in-vehicle device according to the present disclosure includes a communication unit connectable to either a primary line or a secondary line of mobile communication, and a controller configured to cause the communication unit to switch to the secondary line when a failure has occurred in the primary line, in which the controller is configured to execute, when a condition under which communication through the primary line for providing a service to a user is disconnectable is satisfied, switching processing of causing the communication unit to switch to the secondary line even in a case where the failure has not occurred in the primary line.

With the in-vehicle device and the like in the present disclosure, it is possible to smoothly check connectivity of a line.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration example of an in-vehicle device;

FIG. 2A is a flowchart diagram illustrating an operation example of the in-vehicle device; and

FIG. 2B is a flowchart diagram illustrating an operation example of the in-vehicle device.

### DETAILED DESCRIPTION OF EMBODIMENTS

Hereinafter, embodiments will be described with reference to drawings.

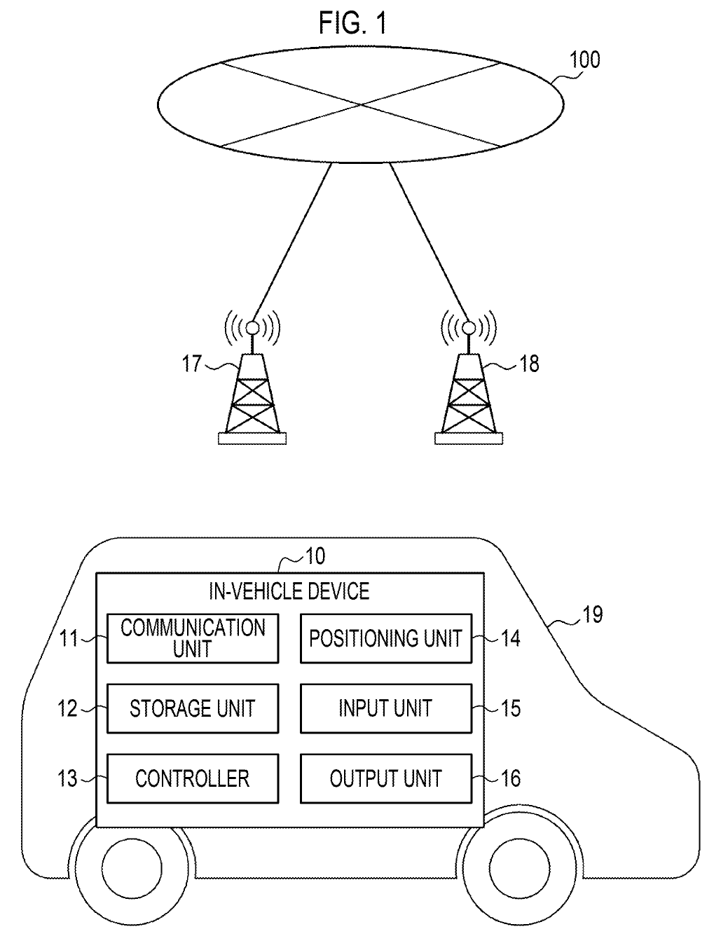

FIG. 1 is a diagram illustrating a configuration example of an in-vehicle device in an embodiment. An in-vehicle device 10 is mounted in a vehicle 19 and has a communication unit 11, a storage unit 12, a controller 13, a positioning unit 14, an input unit 15, and an output unit 16. The in-vehicle device 10 is a computer having a communication function and an information processing function and controls an operation of the vehicle 19. The vehicle 19 is a passenger car, a commercial car, or the like in which a part or all of a driving operation are performed manually. In addition, the vehicle 19 is an internal combustion vehicle, a hybrid electric vehicle (HEV), a plug-in hybrid electric vehicle (PHEV), or the like. The in-vehicle device 10 is configured to be capable of connecting to a base station 17 or 18 of mobile communication wirelessly by the communication unit 11. The base stations 17 and 18 are base stations of mobile communication lines operated by each of different mobile communication providers. The in-vehicle device 10 is connected to a network 100 via the base station 17 or 18. The network 100 includes, for example, the Internet, an ad hoc network, a local area network (LAN), a metropolitan area network (MAN), or a combination of any of the aforementioned.

The in-vehicle device 10 performs, for example, various types of information communication via the network 100 through the primary line in a normal case and through the secondary line in a case where a failure occurs in the primary line, and provides an information service to a user of the vehicle 19. For example, the primary line is a mobile communication line connected by the base station 17, and the secondary line is a mobile communication line connected by the base station 18. The information service includes traffic information provision, transmission of emergency call, remote control, theft tracking, and the like. The primary line and the secondary line are set optionally based on, for example, a fee setting according to a contract form. For example, the primary line is assumed to be always connected and used for relatively large amounts of data communication, and corresponds to a contract form such as a fixed fee plan that is relatively inexpensive per unit data amount. In addition, the secondary line is assumed to be temporarily connected and used for a relatively small amount of data communication in a case where a failure occurs in the primary line, and corresponds to a contract form such as a usage-based plan that is relatively expensive per unit data amount.

In the present embodiment, the in-vehicle device 10 has the communication unit 11 that is connectable to any of the primary line and the secondary line of the mobile communication, and the controller 13 that causes the communication unit 11 to switch to the secondary line in a case where a failure occurs in the primary line. The controller 13 executes switching processing of causing the communication unit 11 to switch to the secondary line even in a case where the failure does not occur in the primary line, in a case where a condition under which communication through the primary line for providing a service to the user is disconnectable (hereinafter, referred to as a disconnection-permissible condition) is satisfied. The disconnection-permissible condition is a condition that is satisfied in a case where a probability that the user uses the information service is relatively low. For example, an example of the disconnection-permissible condition is a predetermined time slot such as late night. An example of the disconnection-permissible condition is a case where a predetermined time has elapsed after it is estimated that the user has left the vehicle 19 after the vehicle 19 in which the in-vehicle device 10 is mounted is stopped. An example of the disconnection-permissible condition is that the network 100 can be connected via an access point in the vicinity by a short-range wireless module such as Wi-Fi (registered trademark). The disconnection-permissible condition is any one or more of the examples. Then, the controller 13 executes the switching processing to determine presence or absence of a failure in the secondary line. In this manner, it is possible to check a communication situation of the secondary line while a concern that the convenience of the user may be reduced is suppressed even in a case where the information service to the user is interrupted. That is, it is possible to smoothly check connectivity of the line. In this manner, it is possible to more reliably ensure that the information service provision to the user is continued by switching to the secondary line in a case where the failure occurs in the primary line.

The communication unit 11, the storage unit 12, the controller 13, the positioning unit 14, the input unit 15, and the output unit 16 of the in-vehicle device 10 may be configured as one control device or may be configured by two or more control devices or by a control device and another device such as a communication machine. The control device includes, for example, an electronic control unit (ECU). The communication machine includes, for example, a data communication module (DCM). Each of the units is connected to each other or to other equipment of the vehicle 19 via an in-vehicle network conforming to a standard such as controller area network (CAN), so that information communication can be performed.

The communication unit 11 has, for example, a module corresponding to a mobile object communication standard such as long term evolution (LTE), 4th generation (4G), or 5th generation (5G). In addition, the communication unit 11 has, for example, a short-range wireless communication module such as Wi-Fi or Bluetooth (registered trademark) or a module corresponding to an in-vehicle LAN such as CAN. The in-vehicle device 10 is configured to be selectively connected to the base station 17 or 18 by the communication unit 11, and is connected to the network 100 using the mobile communication line corresponding to each base station. In addition, the in-vehicle device 10 performs information communication with each unit of the vehicle 19 via the in-vehicle LAN. Further, in a case where an access point that can be connected by short-range wireless is present in the vicinity, the in-vehicle device 10 can connect to the network 100 by connecting to the access point.

The storage unit 12 includes one or more semiconductor memories, one or more magnetic memories, one or more optical memories, or a combination of at least two types thereof. The semiconductor memory is, for example, a random access memory (RAM) or a read only memory (ROM). The RAM is, for example, a static RAM (SRAM) or a dynamic RAM (DRAM). The ROM is, for example, an electrically erasable programmable ROM (EEPROM). The storage unit 12 functions, for example, as a main storage device, an auxiliary storage device, or a cache memory. The storage unit 12 stores information used in an operation of the controller 13 and information obtained by the operation of the controller 13.

The controller 13 includes one or more processors, one or more dedicated circuits, or a combination thereof. The processor is a general-purpose processor such as a central processing unit (CPU) or a dedicated processor such as a graphics processing unit (GPU) specialized in specific processing. The dedicated circuit is, for example, a field-programmable gate array (FPGA) or an application specific integrated circuit (ASIC). The controller 13 executes information processing related to an operation of the in-vehicle device 10 while each unit of the in-vehicle device 10 is controlled.

The functions of the controller 13 are implemented by executing a control/processing program with the processor included in the controller 13. The control/processing program is a program for causing a computer to implement a function corresponding to processing of a step included in the operation of the controller 13 by causing the computer to execute the processing of the step. That is, the control/processing program is a program for causing the computer to function as the controller 13. In addition, a part or all of the functions of the controller 13 may be implemented by the dedicated circuit included in the controller 13.

The positioning unit 14 includes one or more global navigation satellite system (GNSS) receivers. The GNSS includes, for example, at least any of a global positioning system (GPS), a quasi-zenith satellite system (QZSS), BeiDou, a global navigation satellite system (GLONASS), or Galileo. The positioning unit 14 transmits a positioning result to the controller 13, and the controller 13 obtains position information of the in-vehicle device 10.

The input unit 15 includes one or more input interfaces. The input interface is, for example, a microphone that receives voice input, a physical key, a capacitive key, a pointing device, or a touch screen that is provided integrally with a display. The input unit 15 receives an operation of inputting information used in the operation of the controller 13 and transmits the input information to the controller 13.

The output unit 16 includes one or more output interfaces. The output interface is, for example, a speaker or a display. The display is, for example, a liquid crystal display (LCD) or an organic electro-luminescence (EL) display. The output unit 16 outputs information obtained by the operation of the controller 13. For example, the speaker of the output unit 16 outputs a voice for a warning to a driver based on the information output by the controller 13.

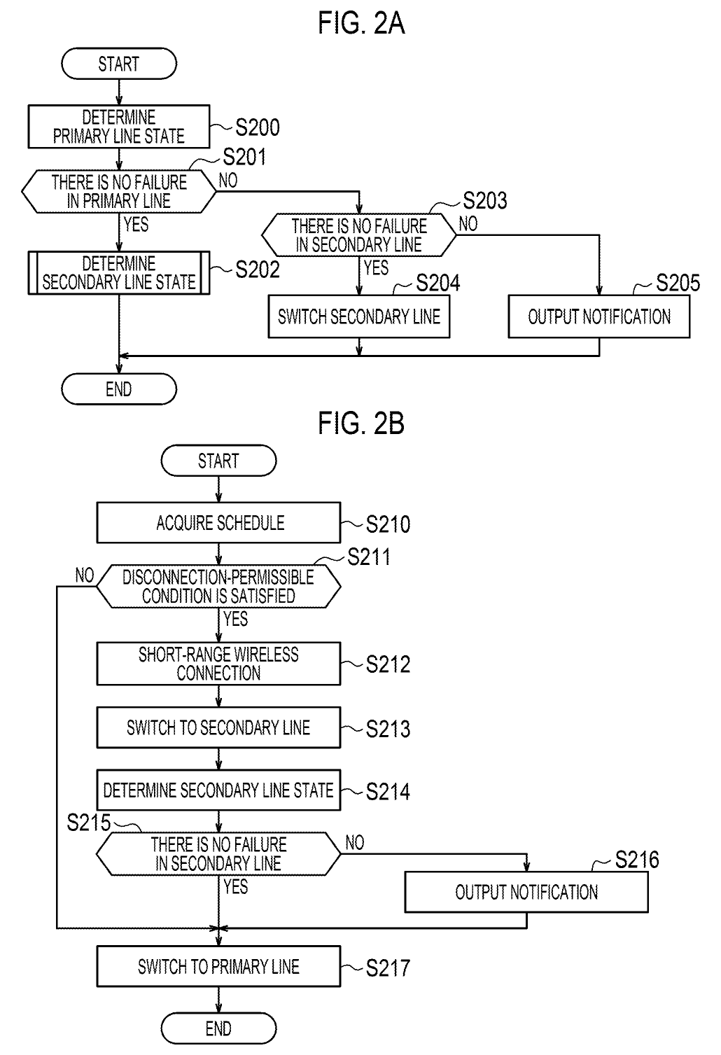

FIGS. 2A and 2B are flowchart diagrams for describing an operation procedure of the in-vehicle device 10 in the present embodiment. Each step in FIGS. 2A and 2B is a step of information processing executed by the controller 13.

The procedure in FIG. 2A is a procedure of switching to the secondary line during a failure in the primary line. The procedure in FIG. 2A is executed at any timing during the operation of the in-vehicle device 10. First, the controller 13 determines a state of the primary line by the communication unit 11 (S200). The controller 13 determines presence or absence of the failure by determining whether a signal intensity, a signal quality, and the like in communication with the base station 17 by the communication unit 11 satisfy a criterion. Then, in a case where the failure does not occur in the primary line (Yes in S201), the controller 13 determines a state of the secondary line (S202), and ends the procedure in FIG. 2A. On the other hand, in a case where the failure occurs in the primary line (No in S201), the controller 13 determines presence or absence of a failure in the secondary line with reference to a determination result of the state of the secondary line in a previous processing cycle (S203). In a case where the failure does not occur in the secondary line (Yes in S203), the controller 13 causes the communication unit 11 to switch from the primary line to the secondary line (S212). On the other hand, in a case where the failure occurs in the secondary line (No in S203), the controller 13 outputs a notification indicating that the failure has occurred in the primary line and the secondary line (S205), and ends the procedure in FIG. 2A. Such a notification is output by the output unit 16 by displaying characters or by voice. Accordingly, the user can recognize that the failure has occurred in both the primary line and the secondary line at least at a current position of the in-vehicle device 10 and that the information service cannot be utilized, and can consider countermeasures such as moving to another point and inspecting the device.

The procedure in FIG. 2B is a detailed procedure of S202. First, the controller 13 acquires, for example, schedule information of the user (S210). For example, the controller 13 acquires the schedule information from a server in which the schedule information of the user is registered, via the network 100. Next, the controller 13 determines whether the disconnection-permissible condition is satisfied (S211). For example, the controller 13 determines that the disconnection-permissible condition is satisfied in a case of a predetermined time slot such as late night. Such a predetermined time slot is set in advance by the operation of the input unit 15 by the user. In addition, the controller 13 determines that the disconnection-permissible condition is satisfied in a case where a predetermined time has elapsed after the vehicle 19 is stopped. In a case where the controller 13 detects that the vehicle 19 is parked based on a state of an engine, a brake, a gear, and the like of the vehicle 19, the controller 13 measures a time from the point in time and determines whether the elapsed time has reached any criterion, so that the lapse of the time is determined. In this case, the in-vehicle device 10 is operated by power supply from a battery for a certain time after the engine is stopped. In addition, in a case where the communication unit 11 can connect to the network 100 via the access point such as Wi-Fi in the vicinity, the controller 13 determines that the disconnection-permissible condition is satisfied. Then, in a case where the disconnection-permissible condition is satisfied (Yes in S211), the controller 13 connects to the access point in the vicinity by the short-range wireless in a case where the disconnection-permissible condition is satisfied by a condition of the short-range wireless (S212). In a case where the disconnection-permissible condition is satisfied by a condition other than the short-range wireless connection, S212 may be omitted. Then, the controller 13 causes the communication unit 11 to switch to the secondary line (S213). On the other hand, in a case where the disconnection-permissible condition is not satisfied (No in S211), the controller 13 switches the connection of the communication unit 11 to the primary line (S217), and ends the procedure in FIG. 2B.

Next, the controller 13 determines the state of the secondary line by the communication unit 11 (S214). The controller 13 determines presence or absence of the failure by determining whether the signal intensity, the signal quality, and the like in communication with the base station 18 by the communication unit 11 satisfy the criterion. The determination result is stored in the storage unit 12. Then, in a case where the failure does not occur in the secondary line (Yes in S215), the controller 13 switches the connection of the communication unit 11 to the primary line (S217), and ends the procedure in FIG. 2B. On the other hand, in a case where the failure occurs in the secondary line (No in S215), the controller 13 outputs a notification indicating that the failure has occurred in the secondary line (S216). Such a notification is output by the output unit 16 by displaying characters or by voice. Accordingly, the user can recognize that the information service cannot be utilized even in a case where the in-vehicle device 10 is switched from the primary line to the secondary line at least at the current position and can consider countermeasures such as moving to another point and inspecting the device. Then, the controller 13 switches the connection of the communication unit 11 to the primary line (S217), and ends the procedure in FIG. 2B.

As described above, according to the present embodiment, it is possible to check the communication situation of the secondary line while a concern that the convenience of the user may be reduced is suppressed even in a case where the information service to the user is interrupted. That is, it is possible to smoothly check connectivity of the line.

In the description, the embodiment has been described based on the drawings and examples, but it should be noted that a person skilled in the art can easily make various modifications and repairs based on the present disclosure. Accordingly, it should be noted that the modifications and repairs are included in the scope of the present disclosure. For example, functions included in each unit, each step, and the like can be reorganized not to be logically contradictory, and a plurality of units, steps, and the like can be combined into one or divided.

What is claimed is:

1. An in-vehicle device comprising:
a communication unit connectable to either a primary line or a secondary line of mobile communication; and
a controller configured to cause the communication unit to switch to the secondary line when a failure has occurred in the primary line,
wherein the controller is configured to execute, when an access point connectable by short-range wireless is present in a vicinity of the controller, switching processing of causing the communication unit to switch to the secondary line even in a case where the failure has not occurred in the primary line.

2. An in-vehicle device comprising:
a communication unit connectable to either a primary line or a secondary line of mobile communication; and
a controller configured to cause the communication unit to switch to the secondary line when a failure has occurred in the primary line,
wherein the controller is configured to execute, when a condition under which communication through the primary line for providing a service to a user is disconnectable is satisfied, switching processing of causing the communication unit to switch to the secondary line even in a case where the failure has not occurred in the primary line.

3. The in-vehicle device according to claim 2, wherein the controller is configured to execute the switching processing to determine presence or absence of a failure in the secondary line.

4. The in-vehicle device according to claim 2, wherein the condition is at least one of a predetermined time slot being satisfied, a predetermined time having elapsed after a vehicle in which the in-vehicle device is mounted is stopped, and a public communication network being connectable via a short-range wireless module.

5. The in-vehicle device according to claim 4, wherein the predetermined time is based on schedule information of the user of the vehicle in which the in-vehicle device is mounted, or is set by the user.
